(19) United States
(12) Patent Application Publication
(10) Pub. No.: US 2012/0034512 A1
(43) Pub. Date: Feb. 9, 2012

(54) LITHIUM ALLOY-CARBON COMPOSITE NANOFIBERS AND METHODS OF FABRICATION

(75) Inventors: Xiang-wu Zhang, Cary, NC (US); Peter S. Fedkiw, Raleigh, NC (US); Saad A. Khan, Cary, NC (US)

(73) Assignee: NORTH CAROLINA STATE UNIVERSITY, Raleigh, NC (US)

(21) Appl. No.: 13/231,433

(22) Filed: Sep. 13, 2011

Related U.S. Application Data
(63) Continuation of application No. PCT/US2010/026625, filed on Mar. 9, 2010.
(60) Provisional application No. 61/160,081, filed on Mar. 13, 2009.

(51) Int. Cl. H01M 4/583; D04H 13/00; D01F 9/14; B29C 47/00; H01M 2/02; D02G 3/00; B82Y 40/00

(52) U.S. Cl. 429/163; 429/231.8; 429/231.95; 442/334; 428/373; 264/29.2; 264/465; 977/900

(57) ABSTRACT

A carbon/nanoparticle nanofiber includes a carbon base structure and a plurality of nanoparticles that include a lithium alloy or a lithium alloy precursor. One or more nanofibers may be formed into a nonwoven fabric. The fabric may be utilized as an electrode, such as for example in a battery. The carbon/nanoparticle composite nanofiber may be fabricated by forming a polymer/nanoparticle nanofiber, such as for example by a spinning technique, and carbonizing the polymer/nanoparticle nanofiber.

### RELATED APPLICATIONS

This application is a continuation of International Application No. PCT/US2010/026625, filed Mar. 9, 2010, titled “LITHIUM ALLOY-CARBON COMPOSITE NANOFIBERS AND METHODS OF FABRICATION”, which claims the benefit of U.S. Provisional Patent Application Ser. No. 61/160,081, filed Mar. 13, 2009, titled “LITHIUM ALLOY-CARBON COMPOSITE NANOFIBERS AND METHODS OF FABRICATION”, the contents of which are incorporated by reference herein in their entireties.

### FEDERALLY SPONSORED SUPPORT

This invention was made with government support under Grant No. DMI-0555959 by the National Science Foundation. The United States Government may have certain rights in the invention.

### TECHNICAL FIELD

The present invention relates generally to nanofibers suitable for use as electrodes for various applications entailing the storage of electrical energy. More specifically, the present invention relates to composite nanofibers suitable for use as anodes in batteries, particularly rechargeable (secondary) batteries such as lithium-ion batteries.

### BACKGROUND

Among the various existing energy storage technologies, rechargeable lithium-ion (Li-ion) batteries are considered an effective solution to the increasing need for high-energy density electrochemical power sources. Rechargeable (or “secondary”) Li-ion batteries offer energy densities 2-3 times higher and power densities 5-6 times higher than conventional nickel-cadmium (Ni—Cd) and nickel-metal hydride (Ni-MH) batteries. As a result, Li-ion batteries weigh less, take up less space, and deliver more energy as compared to other types of batteries. Other advantages of Li-ion batteries include high coulombic efficiency, low self-discharge, high operating voltage, and no “memory effect.”

Graphite is presently the most utilized anode material for Li-ion batteries due to its low and flat working potential, long cycle life, and low cost. However, the most lithium-enriched intercalation compound of graphite has a stoichiometry of only LiC₆, resulting in less than desirable theoretical charge capacity (370 mAh/g). In addition to graphite, other carbonaceous materials can intercalate lithium, such as carbon fiber, petroleum coke and pyrolytic carbons, but their capacities are also low.

In addition to carbon materials, lithium alloys can also be utilized as anode materials. Typically, lithium alloys incorporate large amounts of lithium and hence have high capacities. For example, Li_{4.4}Si and Li_{4.4}Sn have theoretical capacities of 4200 and 999 mAh/g, respectively. The major problem associated with the use of lithium alloys is the mechanical failure brought about by large-volume changes during lithium insertion/extraction. Efforts have been carried out to improve lithium alloy cycle life including: i) alloying the metal host (e.g., silicon (Si) or tin (Sn)) with an inactive metal element (e.g., zirconium (Zr), nickel (Ni), iron (Fe) and chromium (Cr)) to form intermetallics; ii) replacing the metal host with a metal oxide (e.g., SnO₂) and iii) reducing the particle size to nanoscale. These methods, however, only partially accommodate the volume change and the resulting anode materials still have limited cycle life.

Another problem with anodes of presently-known design is that they require the presence of inactive materials. For example, presently available anodes for lithium-ion batteries are fabricated by binding active materials (active carbon, or lithium alloy) with polymer binders. Also, carbon black is added to provide sufficient electron conductivity. The presence of inactive materials such as polymer binder and carbon black reduces the overall energy and power densities of batteries employing these presently available anodes.

Accordingly, an ongoing need remains for electrode materials with improved properties, including those associated with batteries and other energy storage devices.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a nonwoven fabric includes one or more composite nanofibers including a carbon base structure and a plurality of nanoparticles retained by the carbon base structure, the nanoparticles including a lithium alloy or a lithium alloy precursor.

The lithium alloy precursor may be any component capable of alloying with lithium, particularly in response to the migration of lithium ions in a battery or other device in which the composite nanofiber fabric is utilized as an electrode. The lithium alloy precursor may be a metal, metalloid, metal oxide, inorganic salt, or an organic salt. Non-limiting examples of metals suitable for use as lithium alloy precursors include tin, aluminum, iron, zinc, cobalt, nickel, antimony, silver, copper, molybdenum, iron, manganese, magnesium, etc. Additionally, the lithium alloy precursor may be an intermetallic that includes a combination of two or more of the foregoing metals, or one of the foregoing metals and one or more other metals. Non-limiting examples of metalloids suitable for use as lithium alloy precursors include silicon. Non-limiting examples of metal oxides suitable for use as lithium alloy precursors include tin oxide, alumina, titanium oxide, cobalt oxide, ferrous oxide, manganese oxide, molybdenum oxide, etc. Non-limiting examples of inorganic and organic salts include cobalt chloride, cobalt acetate, cobalt carbonyl, cobalt acetylacetonate, bis(cyclopentadienyl)cobalt, manganese acetylacetonate, manganese sulfate, iron acetate, silicon tetrachloride, silicon tetrabromide, silicon 2,3-naphthalocyanine dichloride.

According to another implementation, an electrode includes one or more composite nanofibers including a carbon base structure and a plurality of nanoparticles retained by the carbon base structure, the nanoparticles including a lithium alloy or a lithium alloy precursor. A nonwoven fabric or layer of the nanofiber(s) may be disposed on an electrically conductive structure.

According to another implementation, a secondary battery includes an anode, a cathode separated from the anode by a gap, and an electrolyte disposed in the gap between the anode and the cathode. The anode includes one or more composite nanofibers including a carbon base structure and a plurality of nanoparticles retained by the carbon base structure, the nanoparticles including a lithium alloy or a lithium alloy precursor. The electrolyte includes a material capable of transferring lithium ions between the anode and the cathode in response to charging or discharging the secondary battery.

According to another implementation, the secondary battery includes a housing enclosing the anode, the cathode and the electrolyte.

According to another implementation, the secondary battery includes a first electrically conductive structure and a second electrically conductive structure, wherein the anode is disposed on and in electrical communication with the first electrically conductive structure, and the cathode is disposed on and in electrical communication with the second electrically conductive structure. One or both of the first electrically conductive structure and the second electrically conductive structure may form or be part of a housing enclosing the anode, the cathode and the electrolyte.

According to another implementation, the secondary battery includes a separator disposed in the gap between the anode and the cathode and immersed in the electrolyte, wherein electrolyte includes a non-solid material.

According to another implementation, the electrolyte includes a solid material.

According to another implementation, a method is provided for fabricating a carbon/nanoparticle composite nanofiber. A polymer/nanoparticle nanofiber is formed. The polymer/nanoparticle nanofiber includes a polymer base structure and a plurality of nanoparticles retained by the polymer base structure. The nanoparticles include a lithium alloy or a lithium alloy precursor. The polymer/nanoparticle nanofiber is carbonized, wherein the polymer base structure is transformed to a carbon base structure and the nanoparticles are retained by the carbon base structure.

A wide variety of polymers may be utilized as a starting materials, examples of which are given below.

According to another implementation, a carbon/nanoparticle composite nanofiber is fabricated according to the above method.

According to another implementation, a nonwoven fabric or mat is fabricated from one or more nanofibers fabricated according to the above method.

According to another implementation, an electrode is provided that includes one or more nanofibers fabricated according to the above method.

According to another implementation, an electrical or electronic device is provided that includes an electrode. The electrode includes one or more nanofibers fabricated according to the above method.

In some implementations, nanofiber(s) may be formed by first forming one or more polymer/nanoparticle nanofibers, followed by a process that transforms the polymer component to the carbon component.

According to another implementation, a method is provided for fabricating a non-woven carbon/nanoparticle composite fabric. One or more nanofibers are formed including a carbon base structure and a plurality of nanoparticles retained by the carbon base structure, the nanoparticles including a lithium alloy precursor. In some implementations, one or more layers of nanofibers may be formed to fabricate the fabric.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a nonwoven composite nanofiber fabric provided in accordance with certain implementations of the present disclosure.

FIG. 2 is a schematic view of an example of an apparatus for electrospinning nanofibers that may be utilized in accordance with certain implementations of the present disclosure.

FIG. 3 is a schematic cross-sectional view of an example of a rechargeable (secondary) Li-ion battery including an anode provided in accordance with certain implementations of the present disclosure.

FIG. 4 is a set of SEM images of Si/PAN composite nanofibers with different Si contents: (a, b) 0 (pure PAN), (c, d) 5, (e, f) 10, and (g, h) 15 wt %.

FIG. 5 is a set of TEM images of Si/PAN composite nanofibers with different Si contents: (a) 5, (b) 10, and (c) 15 wt %.

FIG. 6 is a set of DSC thermograms of Si/PAN composite nanofibers with different Si contents: (a) 0 (pure PAN), (b) 5, (c) 10, (d) 15, and (e) 30 wt %.

FIG. 7 is a set of TGA thermograms of Si/PAN composite nanofibers with different Si contents: (a) 0 (pure PAN), (b) 5, (c) 10, (d) 15, and (e) 30 wt %.

FIG. 8 is a comparison of TEM images of (a) 15 wt % Si/PAN and (b, c) the corresponding Si/C composite nanofibers.

FIG. 9 illustrates WAXD patterns (A) and Raman spectra (B) of Si/C composite nanofibers made from 15 wt % Si/PAN precursor.

FIG. 10 illustrates Galvanostatic charge-discharge curves (A) and cycling performance (B) of Si/C composite nanofiber anode made from 15 wt % Si/PAN precursor. Current density: 100 mA g⁻¹.

FIG. 11 illustrates Rate capability (capacity vs. current density) of Si/C composite nanofiber anode made from 15 wt % Si/PAN precursor and graphite.

### DETAILED DESCRIPTION

For purposes of the present disclosure, it will be understood that when a layer (or coating, film, region, substrate, component, device, or the like) is referred to as being “on” or “over” another layer, that layer may be directly or actually on (or over) the other layer or, alternatively, intervening layers (e.g., buffer layers, transition layers, interlayers, sacrificial layers, etch-stop layers, masks, electrodes, interconnects, contacts, or the like) may also be present. A layer that is “directly on” another layer means that no intervening layer is present, unless otherwise indicated. It will also be understood that when a layer is referred to as being “on” (or “over”) another layer, that layer may cover the entire surface of the other layer or only a portion of the other layer. It will be further understood that terms such as “formed on” or “disposed on” are not intended to introduce any limitations relating to particular methods of material transport, deposition, fabrication, surface treatment, or physical, chemical, or ionic bonding or interaction.

As used herein, the term “nanofiber” refers generally to an elongated fiber structure having an average diameter ranging from about 10 nm-5 μm in some examples, and in other examples ranging from about 20 nm-2 μm. The “average” diameter may take into account not only the fact that the diameters of individual nanofibers making up a plurality of nanofibers formed by implementing the presently disclosed method may vary somewhat, but also that the diameter of an individual nanofiber may not be uniform over its length in some implementations of the method. The average length of the nanofibers may range from 100 nm or greater. In other examples, the average length ranges from 100 nm to millions of nm The aspect ratio (length/diameter) of the nanofibers may range from 20 or greater. In other examples, the aspect ratio may range from 20 to millions. In other examples, the aspect ratio may range from 50 to millions. Insofar as the diameter of the nanofiber may be on the order of a few microns, for convenience the term “nanofiber” as used herein encompasses both nano-scale fibers and micro-scale fibers (microfibers).

As used herein, the term “nanoparticle” refers generally to any particle that may form a composite with a nanofiber fabricated in accordance with the present teachings. In a typical implementation, the nanoparticle is or includes a lithium alloy or lithium alloy precursor. The average size of nanoparticles may range from 1 to 200 nm. In the present context, the term “size” takes into account the fact that the nanoparticles may exhibit irregular shapes such that “size” corresponds to the characteristic dimension of the nanoparticles. For example, if the shapes of the nanoparticles are approximated as spheres, the characteristic dimension may be considered to be a diameter. As another example, if the shapes of the nanoparticles are approximated as prisms or polygons (i.e., rectilinear dimensions), the characteristic dimension may be considered to be a predominant length, width, height, etc.

The fabrication of electrospun polymer composite nanofibers containing different inorganic nanoparticles has gained significant attention primarily due to the potential of combining distinct properties of organic and inorganic moieties within a single hybrid composite. These resultant composite nanofibers may possess useful carrier mobility, band gap tenability, a range of magnetic and dielectric properties, and thermal and mechanical stability of inorganic components. At the same time, the low weight and structural flexibility of polymers can also be preserved. In addition, new or enhanced phenomena can arise from the composite nanofibers as a result of their high interfacial areas, extremely long length, and complex pore structure. As taught herein, in addition to polymer composite nanofibers, inorganic nanoparticle-filled carbon nanofibers may also be readily obtained by the thermal treatment of electrospun polymer composite fibers at elevated temperatures. These transformed carbon nanofibers display great promise in the area of catalysts, chemical/biological sensing, optoelectronic and photonic devices, and energy storage and conversion devices.

The present disclosure describes the implementation of nanomanufacturing technology to integrate dissimilar materials into novel composite nanofibers for use in, for example, Li-ion batteries and other electronic devices. In some implementations, these composite nanofibers are fabricated into nonwoven fabrics, which may be utilized directly as anodes and hence eliminate the need for non-active materials such as conducting carbon black and polymer binder. These anodes have the advantages of high capacity, long cycle life, high-energy and high-power densities, large rate capacity, good low-temperature performance, and low cost.

In some implementations, a spinning technique such as electrospinning is utilized to synthesize lithium alloy precursor-inclusive polymer nanofibers, which are subsequently carbonized to produce lithium alloy precursor-inclusive carbon nanofibers. The lithium alloy precursor-inclusive carbon nanofibers may then be lithiated to produce lithium alloy-carbon composite nanofibers. The resultant nanofiber materials combine the advantageous properties of lithium alloy (e.g., high storage capacity) and carbon (e.g., long cycle life) in that the carbon matrix accommodates the large-volume change of the encapsulated lithium alloy nanoparticles during lithium insertion/extraction. These composite nanofibers may be electrospun into nonwoven fabrics, which can be directly utilized as anodes or other components or devices as noted above.

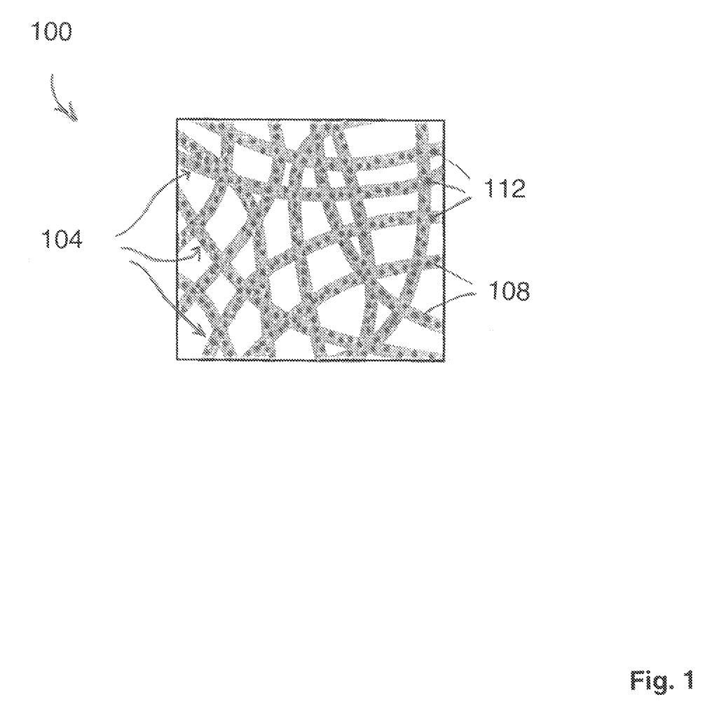

FIG. 1 is a schematic view of an area of a composite nanofiber fabric 100 provided in accordance with the present teachings. The composite nanofiber fabric 100 includes a plurality of nanofibers 104. In various implementations, the composite nanofiber fabric 100 may be characterized as being a mass, matrix, structure, or network of nanofibers 104, one or more layers of nanofibers 104, or the like. In typical implementations, the nanofibers 104 are entangled, as schematically depicted in FIG. 1. In some implementations, the composite nanofiber fabric 100 may be made up of a single, continuous, nanofiber filament that is long enough to form a fabric of a size sufficient for use as an electrode or for making more than one electrode. In this case, the plurality of nanofibers 104 may be considered as being a plurality of contiguous sections or portions of the same lengthy nanofiber 104. Portions of the single nanofiber 104 may be considered as being entangled with each other.

The composite nanofiber fabric 100 may have any suitable area (i.e., planar or two-dimensional size) and shape (e.g., prismatic, circular, etc.), which may depend on such factors as the fabrication technique implemented, the intended end use of the composite nanofiber fabric 100, etc. The composite nanofiber fabric 100 may be fabricated large enough such that smaller pieces may be formed for use as anodes or other intended devices. The thickness of the composite nanofiber fabric 100 (i.e., in the direction into or out from the drawing sheet of FIG. 1, or perpendicular to the area or plane of the nanofiber fabric 100) may range, for example, from a few nanometers to a several (typically less than 10) millimeters. In another example, the thickness may range from 5 nm to 5 mm. In another example, the thickness may range from 5 μm to 5 mm.

Each nanofiber 104 includes an elongated carbon base structure 108 that comprises the primary structure of the nanofiber 104 and predominantly determines the length and diameter of the nanofiber 104. The average length of the nanofibers 104 may range from one or a few micrometers to infinite (i.e., continuous filament). In another example, the average length may range from 100 nm or greater. The average diameter of the nanofibers 104 may range from 10 nanometers to a few micrometers. In another example, the average diameter may range from 10 nm to 5 μm. With respect to diameter, the average may take into account not only the fact that the diameters of individual nanofibers 104 making up the composite nanofiber fabric 100 may vary somewhat, but also that the diameter of an individual nanofiber 104 may not be uniform over its length. The aspect ratio (length/diameter) of the nanofibers 104 may range from 20 or greater.

Each nanofiber 104 further includes a plurality of nanoparticles 112 retained by the carbon base structure 108. Some nanoparticles 112 may be disposed on the outer surface of the nanofiber 104 while other nanoparticles 112 may be embedded in (or encapsulated by) the nanofiber 104. In the present context, the term “retained” encompasses both the state of being positioned “on” the nanofiber 104 and the state of being positioned “in” the nanofiber 104. The average size of the nanoparticles 112 may range, for example, from 1 to 200 nm. In the present context, the term “size” takes into account the fact that the nanoparticles 112 may exhibit irregular shapes such that “size” corresponds to the characteristic dimension of the nanoparticles 112. For example, if the shapes of the nanoparticles 112 are approximated as spheres, the characteristic dimension may be considered to be a diameter. As another example, if the shapes of the nanoparticles 112 are approximated as prisms or polygons (i.e., rectilinear dimensions), the characteristic dimension may be considered to be a predominant length, width, height, etc.

The composition of each nanoparticle 112 includes a lithium alloy precursor (or host). The lithium alloy precursor may be any component capable of alloying with lithium, particularly in response to the migration of lithium ions in a battery or other device in which the composite nanofiber fabric 100 is utilized as an electrode. The lithium alloy precursor may be a metal, metalloid, metal oxide, inorganic salt, or an organic salt. Non-limiting examples of metals suitable for use as lithium alloy precursors include tin, aluminum, iron, zinc, cobalt, nickel, antimony, silver, copper, molybdenum, iron, manganese, magnesium, etc. Additionally, the lithium alloy precursor may be an intermetallic that includes a combination of two or more of the foregoing metals, or one of the foregoing metals and one or more other metals. Non-limiting examples of metalloids suitable for use as lithium alloy precursors include silicon. Non-limiting examples of metal oxides suitable for use as lithium alloy precursors include tin oxide, alumina, titanium oxide, cobalt oxide, ferrous oxide, manganese oxide, molybdenum oxide, etc. Non-limiting examples of inorganic and organic salts include cobalt chloride, cobalt acetate, cobalt carbonyl, cobalt acetylacetonate, bis(cyclopentadienyl)cobalt, manganese acetylacetonate, manganese sulfate, iron acetate, silicon tetrachloride, silicon tetrabromide, silicon 2,3-naphthalocyanine dichloride.

In typical implementations, the lithium alloy precursor-inclusive nanoparticles 112 are positioned with the carbon base structures 108 as the composite nanofibers 104 are formed. After the resulting composite nanofiber fabric 100 is fabricated, the composite nanofiber fabric 100 may be subjected to a lithiation process whereby lithium is alloyed with the lithium alloy precursors, resulting in lithium alloy nanoparticles 112 (i.e., an alloy of lithium and a lithium alloy precursor). In implementations where the composite nanofiber fabric 100 is utilized as an anode in a Li-ion battery, the lithiation process occurs during the charging of the battery. In other implementations, a lithium alloy itself may be provided as a precursor to the formation of the composite nanofibers 104 such that lithium alloy-inclusive nanoparticles 112 are already positioned with the carbon base structures 108 as the composite nanofibers 104 are formed. Accordingly, the nanoparticles 112 depicted in FIG. 1 may represent either lithium alloy precursor compositions or lithium alloy compositions, depending on whether a lithiation process has occurred and/or depending on whether lithium alloy-inclusive nanoparticles 112 were formed prior to a lithiation process.

The nanofibers of the composite nanofiber fabric 100 may be fabricated by any suitable method. In one implementation, polymer nanofibers, with nanoparticles retained thereby, are first formed. The nanoparticles include at least the lithium alloy precursor. The composite polymer-lithium alloy precursor nanofibers are then subjected to a carbonization process by which the polymer base structures of the nanofibers are transformed into carbon base structures to produce composite carbon-lithium alloy precursor nanofibers. The composite carbon-lithium alloy precursor nanofibers may be collected and formed into a nonwoven mat by any suitable means such as by pressing or simply by accumulation. Subsequently, the composite carbon-lithium alloy precursor nanofibers may be lithiated, through a battery charging process or other suitable means, to form composite carbon-lithium alloy nanofibers. The nonwoven mat may be formed into one or more anodes by any suitable means.

In a more specific implementation, an organic polymer is dissolved in a suitable solvent to a desired concentration, and a desired amount of nanoparticles of a suitable lithium alloy precursor (or, in some implementations, a lithium alloy) are added to the solution to a desired concentration. The resulting mixture is stirred or otherwise agitated so as to obtain a homogeneous distribution of the nanoparticles in the solution. The mixture is then subjected to any suitable spinning technique to produce elongated nanofibers including the polymer base structure with the nanoparticles retained thereby. The composite nanofibers are accumulated on or in a suitable receptacle, such as a plate, whereby the composite nanofibers are formed as a fibrous mat. Any steps necessary or desirable for producing a dry, continuous mat may be undertaken. The polymer-nanoparticle nanofiber mat is then placed in a suitable carbonization apparatus such as an electric heat-treating furnace in a suitable environment (e.g., air, inert gas, etc.) and subjected to heat treatment according to a desired temperature or temperature profile. During the heat treatment, the non-carbon components of the polymer are volatized, whereby the polymer-nanoparticle nanofibers are transformed into carbon-nanoparticle nanofibers. Following post-carbonization processing, if desired or needed, the resulting nonwoven carbon-nanoparticle nanofiber mat may be utilized as, or formed into, one or more electrodes. The nanofiber mat may alone be utilized as an electrode, and/or may be placed in contact with the surface of another electrically conductive structure such as a plate, bond pad, contact, interconnect, or the like.

Polymers encompassed by the present disclosure generally may be any naturally-occurring, semi-synthetic or synthetic polymers capable of being fabricated into nanofibers in accordance with the spinning techniques taught herein, particularly for forming elongated carbon structures, and capable of retaining nanoparticles of desired compositions as taught herein. Non-limiting examples of polymers include polymers having a molecular weight (MW) ranging from 5000 to 100,000,000. Further examples include polyethylene (more generally, various polyolefins), polystyrene and other aromatic polymers, cellulose and cellulose-based polymers and derivatives thereof (e.g., cellulose acetate, cellulose triacetate, rayon), poly(L-lactic acid) or PLA, polyacrylonitrile (PAN), polyvinylidene difluoride, conjugated organic semiconducting and conducting polymers, biopolymers such as polynucleotides (DNA) and polypeptides, etc. Other examples of suitable polymers include vinyl polymers such as, but not limited to, polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and 3,4-polychloroprene. Additional examples include nonvinyl polymers such as, but not limited to, poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), poly(tetramethylene-m-benzenesulfonamide). Additional polymers include those falling within one of the following polymer classes: polyolefin, polyether (including all epoxy resins, polyacetal, polyetheretherketone, polyetherimide, and poly(phenylene oxide)), polyamide (including polyureas), polyamideimide, polyarylate, polybenzimidazole, polyester (including polycarbonates), polyurethane, polyimide, polyhydrazide, phenolic resins, polysilane, polysiloxane, polycarbodiimide, polyimine, azo polymers, polysulfide, and polysulfone.

As noted above, the polymer can be synthetic or naturally-occurring. Examples of natural polymers include, but are not limited to, polysaccharides and derivatives thereof such as cellulosic polymers (e.g., cellulose and derivatives thereof as well as cellulose production byproducts such as lignin) and starch polymers (as well as other branched or non-linear polymers, either naturally occurring or synthetic). The polymer may also be pitch (e.g., resin). Exemplary derivatives of starch and cellulose include various esters, ethers, and graft copolymers. The polymer may be crosslinkable in the presence of a multifunctional crosslinking agent or crosslinkable upon exposure to actinic radiation or other type of radiation. The polymer may be homopolymers of any of the foregoing polymers, random copolymers, block copolymers, alternating copolymers, random tripolymers, block tripolymers, alternating tripolymers, derivatives thereof (e.g., graft copolymers, esters, or ethers thereof), and the like.

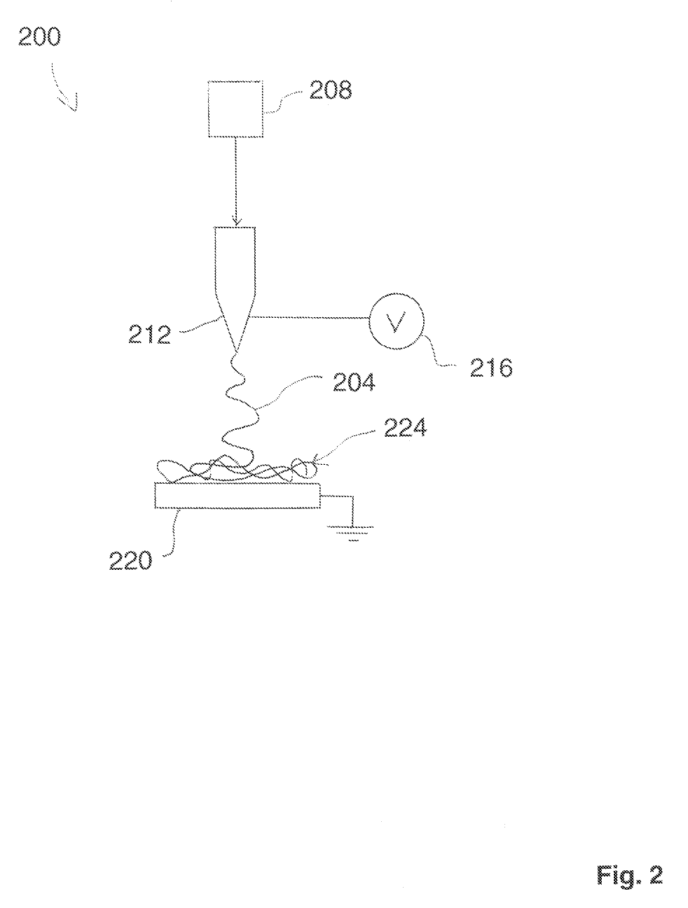

FIG. 2 is a simplified schematic view of an electrospinning apparatus 200 that may be utilized as an example of a spinning technique for forming polymer-nanoparticle nanofibers 204. The electrospinning apparatus 200 may generally include a source 208 of polymer-nanoparticle mixture, which is flowed by any suitable means (e.g., a pump) to a needle 212. The positive electrode of a high-voltage power supply 216 is connected to the tip of the needle 212. The needle 212 is positioned a specified distance from a metallic collector plate 220, which is wrapped in aluminum foil and connected to ground. With flow of the mixture at a specified flow rate established to the needle 212 and a voltage of a specified magnitude applied to the needle 212, polymer-nanoparticle nanofibers 204 are emitted from the needle 212 and accumulate as a nonwoven product 224 on the collector plate 220. The general design, theory and operation of this type of electrospinning apparatus 200 is known to persons skilled in the art and thus need not be described herein in detail. As appreciated by persons skilled in the art, the optimum operating parameters of the electrospinning apparatus 200 (e.g., flow rate, voltage, needle tip-collector plate distance, etc.) will depend on the composition of the polymer-nanoparticle nanofibers 204 to be produced.

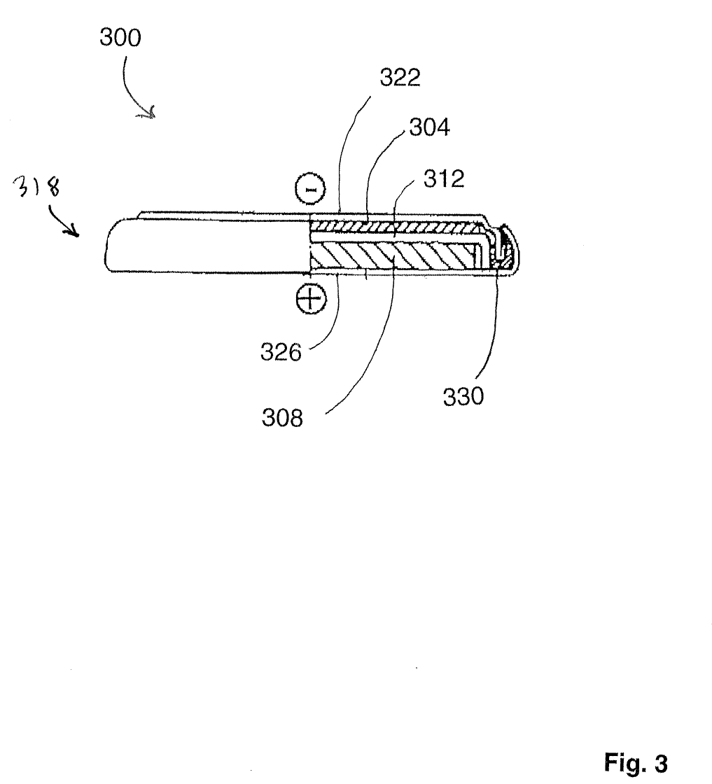

FIG. 3 is a cross-sectional view of an example of a Li-ion battery 300 fabricated according to an implementation of the present disclosure. The Li-ion battery 300 may generally include an anode 304 and a cathode 308 physically separated by a gap by any means suitable for preventing electrical shorting. The anode 304 is, or is fabricated from, a composite nanofiber fabric as described elsewhere in this disclosure. The cathode 308 may have any composition suitable for use as a cathode in Li-ion batteries. Typically, the cathode 308 is lithium or a lithium-inclusive compound such as, for example, lithium cobalt oxide (LiCoO₂), lithium iron phosphate (LiFePO₄), lithium manganese oxide (LiMn₂O₄), lithium nickel oxide (LiNiO₂), or the like. An electrolyte is disposed in the gap between the anode 304 and the cathode 308, and may be in liquid, gel or solid form. The electrolyte may have any composition suitable for functioning as a carrier of lithium ions to and from the anode 304 and cathode 308 in response to the Li-ion battery 300 passing electrical current through an external load or charging device. Typically, the electrolyte is a lithium-inclusive compound, for example a lithium salt such as LiPF₆, LiBF₄ or LiClO₄, in an inorganic solvent such as for example ether. Both the anode 304 and the cathode 308 may be immersed in the electrolyte. The Li-ion battery 300 may also include a solid, micro-porous separator 312 that ensures separation of the anode 304 from the cathode 308 while permitting the passage of lithium ions. The separator 312 may be constructed from various non-electrically conductive polymers and textiles. In some implementations, the separator 312 has a composition that enables it to function as a solid electrolyte.

The Li-ion battery 300 may also include a housing, casing or can 318. In the present example, the housing 318 includes a first electrically conductive portion or structure 322 having a surface in electrical communication (or signal communication) with the anode 304, and a second electrically conductive portion or structure 326 having a surface in electrical communication (or signal communication) with the cathode 308. The first and second conductive portions 322 and 326 may be electrically isolated from each other by any suitable means. In the present example, a deformable gasket 330 is interposed between the first and second conductive portions 322 and 326. In the present example, the first and second conductive portions 322 and 326 serve as an outer protective casing of the Li-ion battery 300, as well as respective negative and positive terminals configured for connection with an external circuit (e.g., load, battery charger, etc.). In the present example, the Li-ion battery 300 may be assembled by positioning the anode 304, cathode 308 and separator 312 in an appropriate manner relative to the first conductive portion 322 and/or second conductive portion 326, introducing the electrolyte by any suitable means (e.g., injection or flowing in the case of liquid electrolyte), and then crimping the first and second conductive portions 322 and 326 together with the gasket 330 serving as a fluid-tight seal. In other examples, the first and second conductive portions 322 and 326 may function primarily as terminals, current collectors and/or electrical conduits in which case additional components are provided to complete an outer protective casing. While FIG. 3 provides a specific example in which the Li-ion battery 300 is configured as a coin-type or button-type cell, it will be appreciated that any other configuration may be implemented, a few non-limiting examples being cylindrical cells, prismatic cells, pouch cells, multi-cell battery packs, and the like, the general designs and operations of which are appreciated by persons skilled in the art.

While particular implementations described thus far have related primarily to anodes as may be utilized in Li-ion batteries, the composite nanofibers provided in accordance with the present teachings may be applied to other types of batteries, including other battery chemistries and both primary and secondary batteries. Moreover, the composite nanofibers may be utilized in various other applications entailing electrical energy storage and current flow including, as non-limiting examples, sensors, photonic and electronic microdevices, biocatalysts, etc.

### EXAMPLE

The following Example describes the fabrication and analysis of carbon/nanoparticle composite nanofibers in which silicon (Si) is utilized as the lithium alloy host or precursor.

Si nanoparticle-incorporated polyacrylonitrile (PAN) nanofibers were prepared using the electrospinning method and Si-filled carbon (Si/C) composite nanofibers were obtained by the subsequent heat-treatment of these Si/PAN nanofibers. Their microstructures were characterized by various analytic techniques. It was found that Si nanoparticles exhibit relatively good dispersion along PAN nanofibers and this is preserved after the formation of Si/C composite nanofibers. The crystal structure characterization indicated that, in Si/C composite nanofibers, Si nanoparticles exist in crystalline state while carbon is in an amorphous or disordered form. Si/C composite nanofibers showed high reversible capacity and good capacity retention when used as anodes for lithium-ion batteries (LIBs). The excellent electrochemical performance of these nanofibers may be ascribed to the combined contributions of carbon matrices and Si nanoparticles, and the special textures and surface properties of the composite nanofibers.

In this Example, Si nanoparticles were incorporated into polyacrylonitrile (PAN) nanofibers, which were then heat-treated to form Si-filled carbon (Si/C) composite nanofibers. Si is a promising anode material for lithium-ion batteries (LIBs). During the charge, each silicon atom can accommodate 4.4 lithium atoms leading to formation of Li₂₂Si₅ alloy, i.e., a theoretical capacity of 4200 mAh g⁻¹, which is more than 10-fold higher than that of graphite (372 mAh g⁻¹) in commercial LIBs. However, the major problem associated with the use of Si is the mechanical failure brought about by the large volume changes during lithium insertion/extraction. Reducing the particle size to nanoscale, the severe volume changes can be partially overcome, but the mechanical failure still exists, leading to limited cycling life of Si nanoparticle anodes. Incorporating a certain amount of Si nanoparticles into carbon nanofibers can alleviate this problem because the carbon matrix can accommodate the mechanical stress induced by the huge volume changes of Si nanoparticles, thus preventing the deterioration of Si material and preserving the integrity of the anode. In addition, the electronic-conducting carbon matrix in the composite nanofibers is an excellent anode material with long cycling life, and hence it can help conduct electrons and provide additional Li insertion capacity. As a result, Si/C composite anodes combine the advantageous properties of both Si nanoparticles (high lithium storage capacity) and carbon (long cycle life and good electric conductivity), and they show high reversible capacity and good capacity retention. Furthermore, their large surface areas can increase the contact between electrode and electrolyte, and reduce lithium-ion diffusion distance, while their extremely long lengths can improve electron transfer rate. As a result, LIBs using Si/C composite nanofiber-based anodes can offer improved energy and power densities, high energy storage and superior cyclability.

In this Example, polyacrylonitrile (PAN) (Mw=150,000) and solvent N,N-dimethylfotlutamide (DMF) were purchased from Aldrich Chemical Company Inc (USA), and Si nanoparticles (average diameter≦70 nm) were obtained from Nanostructured & Amorphous Materials, Inc. All these reagents were used without further purification. PAN solution (8 wt %) in DMF with different amounts of Si nanoparticles (0, 5, 10, 15, 30 wt % with respect to PAN) were prepared in a high purity argon-filled glove box at 60° C. under constant mechanical stirring for at least 12 hours, followed by ultrasonic treatment (FS20H Sonicator, Fisher Scientific) for at least 2 hours. Finally, strong mechanical stirring was applied for at least 24 hours in order to obtain homogeneously distributed Si/PAN solutions.

A variable high voltage power supply (Gamma ES40P-20W/DAM) was used to provide a high voltage (˜17 kV) for electrospinning The flow rate and tip-collector distance were fixed at 0.75 ml h⁻¹ and 15 cm, respectively. The positive electrode of the high voltage power supply was connected to the needle tip. The grounded electrode was connected to a metallic collector wrapped with aluminum foil. Dry fibers were accumulated on the collection plate as a fibrous mat.

The carbonization of the electrospun Si/PAN composite nanofibers was performed in an electric heat-treating furnace (Lucifer Furnaces, Inc.). First, electrospun nanofibers were heated to 280° C. at 5° C. min⁻¹ in an air environment, and this temperature was maintained for 5.5 hours. The temperature was then increased from 280° C. to 700° C. with a heating rate of 2° C. min⁻¹ in high purity argon atmosphere and held at the final temperature for 1 hour in order to complete the carbonization process.

The morphology and diameter of electrospun Si/PAN composite nanofibers were evaluated using scanning electron microscopy (JEOL 6400F Field Emission SEM at 5 kV). The fibers were coated with Au/Pd layers of approximately 100 Å thick by a K-550X sputter coater to reduce charging. Transmission electron microscopy (Hitachi HF-2000 TEM at 200 kV and FEI Tecnai G² Twin at 120 kV) was also used to study the structure of both Si/PAN and Si/C composite nanofibers, which were collected on 200 mesh carbon-coated Cu grids. Thermal properties of electrospun nanofibers were evaluated using differential scanning calorimetery (DSC) from 25 to 400° C. at a heating rate of 10° C. min⁻¹ in nitrogen atmosphere (Perkin Elmer Diamond Series DSC with Intracooler). Thermo-gravimetric analysis (TGA) was used to determine the weight loss of composites at 10° C. min⁻¹ heating rate from 25-800° C. in an air environment (TA Instruments Hi-Res TGA 2950). The nanofiber structural variations were identified by wide angle X-ray diffraction (WARD, Philips X'Pert PRO MRD HR X-Ray Diffraction System, Cu ka, λ=1.5405 Å) and Raman spectra (Horiba Jobin Yvon LabRam Aramis Microscope, 633 nm HeNe Laser).

Galvanostatic charge-discharge experiments were carried out using 2032 coin-type cells (Hohsen Corp.). The as-prepared Si/C composite nanofiber mats were attached onto copper foil (Lyon industries, 0.025 mm thick) to form a working electrode. Separion 5240 P25 (Degussa AG, 25 μm) was used as the separator. A lithium ribbon (Aldrich, 0.38 mm thick) was used as the counter electrode. The electrolyte used was 1 M lithium hexafluorophosphate (LiPF₆), dissolved in ethylene carbonate (EC)/ethyl methyl carbonate (EMC) (1/1 by volume, Ferro Corp.). After the coin cells were assembled, they were sealed by a pressure crimper inside a high purity argon-filled glove box. Charge (lithium insertion) and discharge (lithium extraction) were conducted using an Arbin automatic battery cycler at 100 mA g⁻¹ current density over the range of 0.01 to 2.8 V.

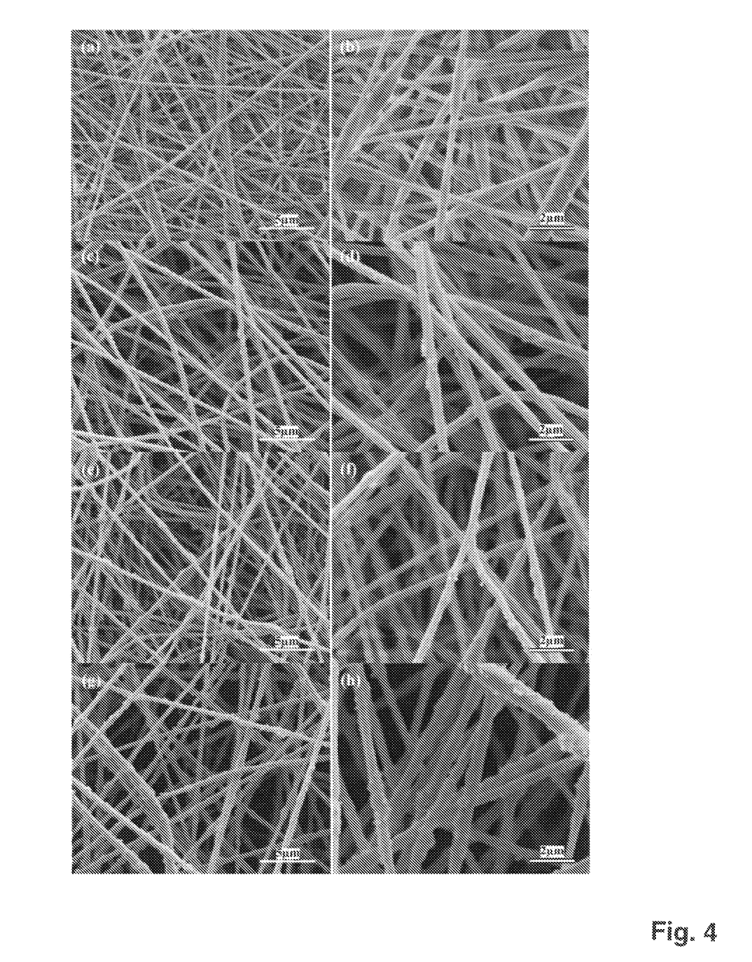

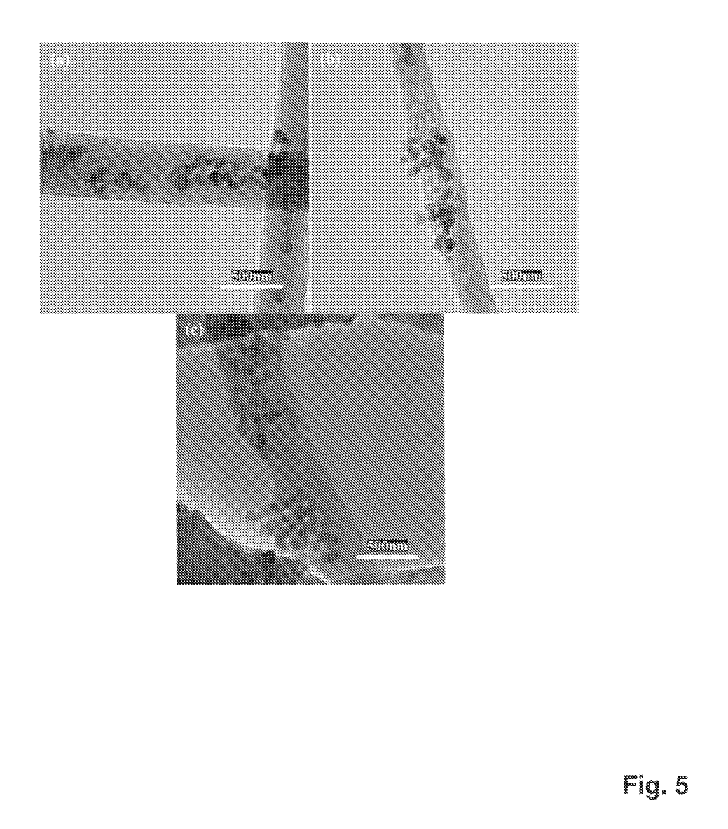

The morphology of Si/PAN nanofibers was examined by SEM and TEM. Typical SEM images of as-prepared Si/PAN composite nanofibers are displayed in FIG. 4. The results show that pure PAN nanofibers have relatively smooth surfaces, and their diameters are in the range of 300 to 400 nm (FIG. 4a). In comparison, Si nanoparticles, in the Si/PAN composite nanofibers, can be clearly seen along PAN nanofibers. When the Si content is low, the quantity of nanoparticles on the surface is sparse (FIG. 4b). With increase in Si content, Si nanoparticles begin to agglomerate, but large Si clusters are still not shown along PAN nanofibers (FIGS. 4(c)-4(h)). The composite nanofiber structure and Si distribution were further studied by TEM images, as shown in FIG. 5. It is found that Si nanoparticles are dispersed along the PAN nanofibers when the Si content is low (such as 5 wt % in FIG. 5a). When the content increases to 10 and 15 wt % (FIGS. 5b and 5c), Si nanoparticles begin to agglomerate; however, large clusters are still absent. These results indicate that PAN stabilizes Si nanoparticles in the electrospinning solution and leads to a relatively homogeneous distribution of Si nanoparticles along the resultant nanofibers, provided the content is not too large.

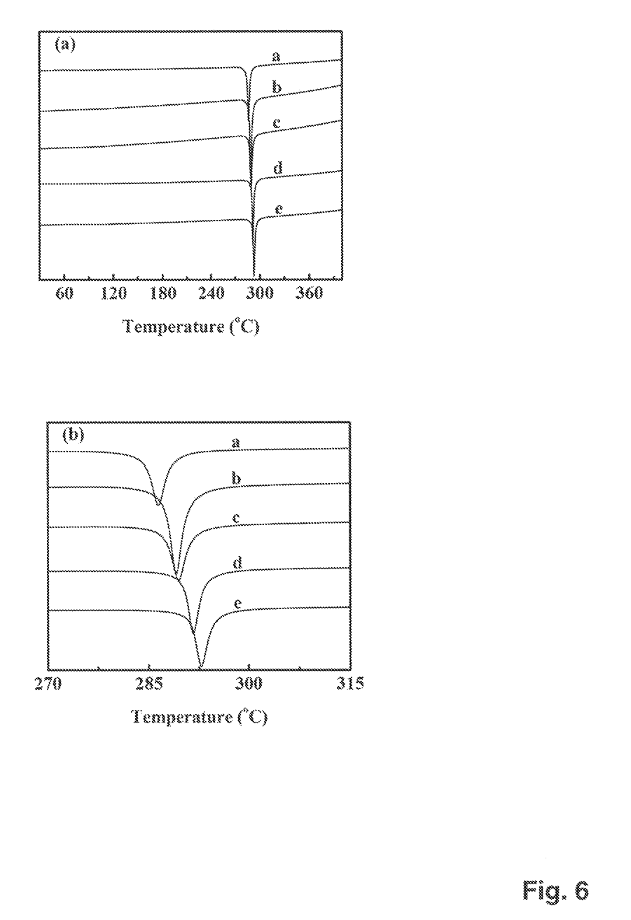

Thermal studies of Si/PAN composite nanofibers were carried out using DSC in nitrogen atmosphere. FIG. 6 shows the DSC thermograms of pure PAN and Si/PAN composite nanofibers. All nanofibers exhibit a relatively large and sharp exothermic peak. It is well known that, during the heat treatment of PAN, several complex chemical reactions take place, such as dehydrogenation, cyclization, and crosslinking, etc. The exothermic peak results from the combination of these reactions, which are exothermic in nature. In addition, in a nitrogen environment, it is easy to form free radicals on the nitrile groups and the subsequent cyclization reactions can take place instantaneously, leading to a sharp exothermic peak. From FIG. 6(b), it is also seen that, with an increase in Si content, the exothermic peak and its onset temperature shift to higher temperatures. The linearly upshifted exothermic peaks with increasing Si content provide experimental evidence that the dispersed Si nanoparticles in nanofibers work as inhibitors, which retard the formation of free radicals on the nitrile groups, hindering the subsequent cyclization reaction.

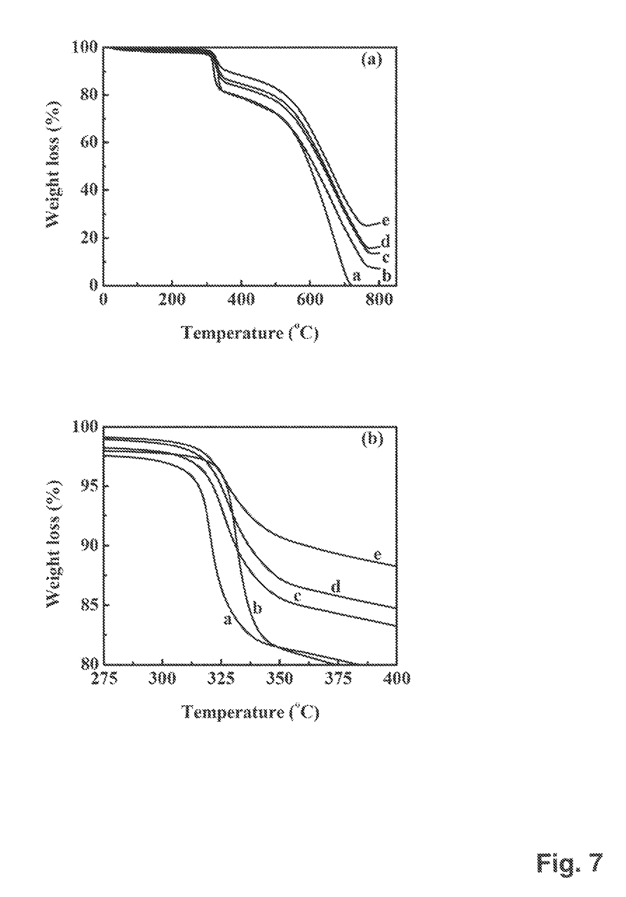

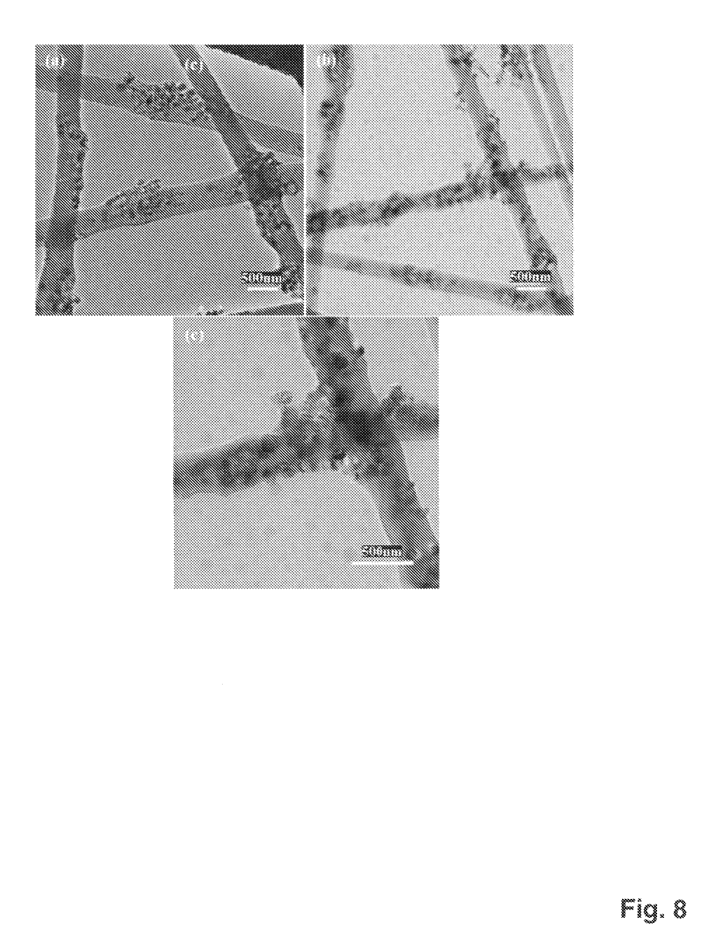

Thermo-gravimetric analysis (TGA) was performed on Si/PAN composite nanofibers in an air environment, and the results are shown in FIG. 7. Pure PAN nanofibers start to have weight loss at around 310° C. The weight loss of the composite nanofibers begins at slightly higher temperatures compared with that of pure PAN nanofibers, and the percentage of total weight loss in composite nanofibers also decreases with the increasing Si content. The TGA thermograms of Si/PAN (5, 10, 15, 30 wt %) composite nanofibers give about 7.1, 13.6, 16.2, 26.2% residuals after reaching 800° C., while pure PAN nanofibers show nearly 100% weight loss in the air environment. Si/C nanofibers were fabricated through further thermal treatment of electrospun Si/PAN precursors. FIG. 8 compares TEM images of Si/C nanofibers with their 15 wt % Si/PAN precursor. It is seen that the distribution of Si nanoparticles in the carbon matrix is similar to that in PAN precursor before carbonization. In addition, the diameter of Si/C composite nanofibers shows a slight decrease compared with the corresponding Si/PAN precursor nanofibers because of the complex physical and chemical reactions (such as carbon densification and gas evolution) involved in carbonization.

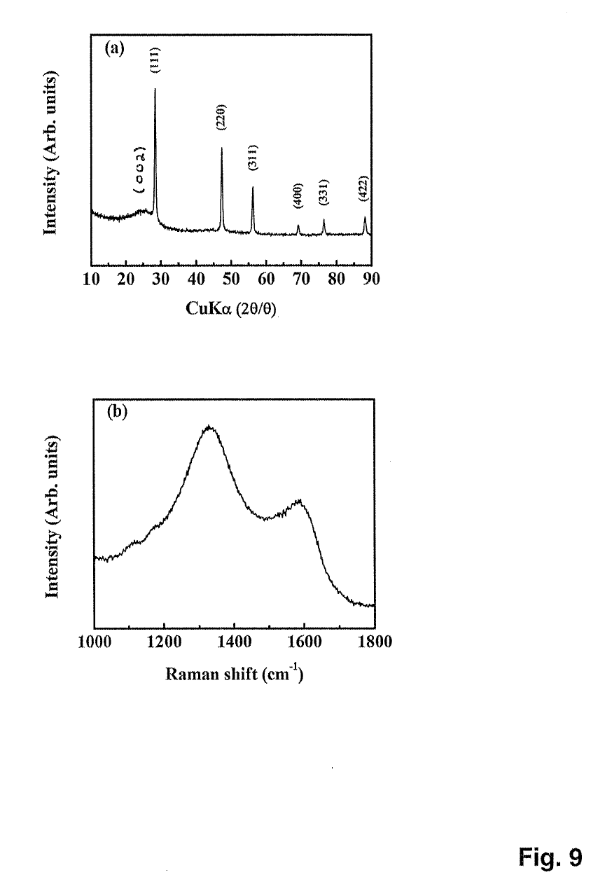

The XRD pattern of Si/C composite nanofiber made from 15 wt % Si/PAN precursor is shown in FIG. 9(a). Si nanoparticles in nanofibers show apparent diffraction peaks at 2θ of 28.4°, 47.4°, 56.2°, 69.2°, 76.5°, and 88.1°, which are ascribed to the (111), (220), (311), (400), (331), and (422) reflection peaks, respectively. These results indicate that crystalline Si nanoparticles exist in a face-centered cubic structure. However, the unclear diffraction peak at 2θ=25°, which corresponds to the (002) layers of the graphite, and the absence of the (100) and (004) line indicate that the carbon matrix derived from Si/PAN precursor has a typical non-graphitic structure. Raman spectra in FIG. 9(b) shows a strong intensity of the D-band at 1354 cm⁻¹(attributed to defect and disordered carbon) and a relatively small intensity of G-band at 1594 cm⁻¹ (E_{2g2} graphitic mode), which are typical for amorphous carbon or disordered graphite. The ratio of the integrated intensity of D peak to G peak, denoted by R_{I}=I_{D}/I_{G}, is greater than 4. These results further indicate the low graphitic degree in the as-prepared Si/C composite nanofibers.

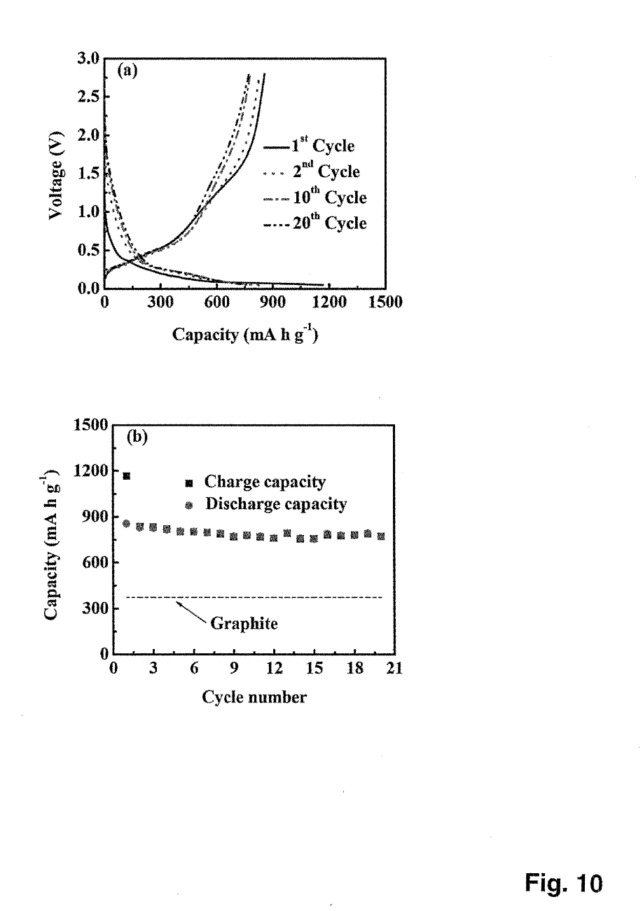

Galvanostatic charge-discharge experiments were carried out at a current density of 100 mA g⁻¹ to evaluate the electrochemical performance of the Si/C nanofiber anode made from 15 wt % Si/PAN precursor at 700° C. FIG. 10(a) shows the electrochemical charge-discharge behavior within a voltage window of 0.01-2.8 V. During the first charge process, there are two sloping voltage ranges (2.8-0.4 V and 0.4-0.01 V vs. Li⁺/Li) that can be discerned. The first slope is attributed to the decomposition of the electrolyte and the formation of the solid electrolyte interphase (SEI) film, and while the second slope in 0.4-0.01 V corresponds to the insertion of lithium into the Si/C nanofiber anode. Typically, the charge capacity related to the first voltage slope is irreversible, but the capacity of the second slope can be reversible if the anode material can withstand the volume change. From FIG. 10(a), it is seen that the Si/C composite nanofiber anode has a charge capacity of 1167 mAh g⁻at the first cycle and the corresponding reversible capacity is about 855 mAh g⁻¹. The irreversible capacity of about 312 mAh g⁻¹, which is much smaller than previously reported results, can be ascribed to the reductive decomposition of electrolyte solution, and the subsequent formation of SEI film during the first cycle. The coulombic efficiency (discharge capacity/charge capacity) at the first cycle is 73.3%. However, after the first cycle, the coulombic efficiency is more than 99%.

FIG. 10(b) compares the cycling performance of the Si/C nanofiber anode and the theoretical value of graphite, which is currently the most widely used anode material. For the Si/C composite nanofiber anode, the reversible capacity at the second cycle is about 831 mAh g⁻¹, which indicates about 97.2% retention of the initial value (855 mAh g⁻¹) at the first cycle. At the tenth and twentieth cycles, the anode still has high reversible capacities of about 781 and 773 mAh g⁻¹, respectively, indicating a very slow fading (91.3 and 90.4% retentions of the initial value, respectively). All these reversible capacities are much larger than the theoretical capacity (372 mAh g⁻¹) of graphite and also the typical capacity (450 mAh g⁻¹) for electrospun pure carbon nanofibers. The improvement in capacity and cycling behavior can be ascribed to the unique Si/C composite nanofiber structure. Si nanoparticles are distributed in the ductile carbon matrices, which prevents the aggregation and separation of Si nanoparticles during lithium insertion and extraction processes. As a result, the severe volume expansion and shrinkage of Si are overcome because of the nano-sized Si crystal structures and the “buffer” effects of carbon matrices. The good electric conductivity of the carbon matrix and the high Li storage of Si are thus combined, leading to high reversible Li⁺ storage capacity and good capacity retention during cycling. In addition, Si/C composite nanofibers have high specific surface area, large surface-to-volume ratio, and extremely long length. These characteristics are beneficial to the anode's electrochemical performance because they lead to a short diffusion length of Li⁺, sufficient contact between electrode and electrolyte, fast Li⁺/electron transfer, and enhanced flexibility. Improved electrode performances such as higher capacity and longer cycling life are accordingly expected.

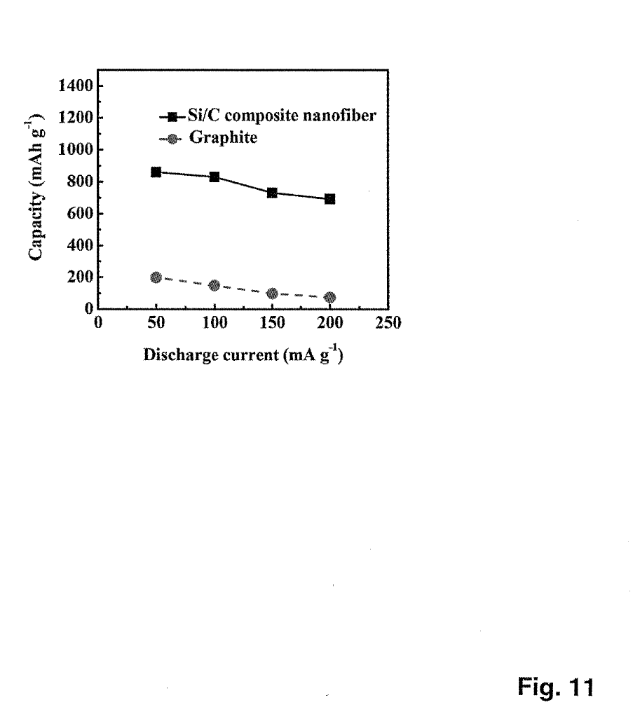

Another challenge of LIBs is the low rate capacity (i.e., the decrease of capacity with increase in current density) of most electrode materials, including conventional graphite and pure carbon nanofiber anodes. FIG. 11 shows the capacities of Si/C composite nanofiber anode at different current densities (50, 100, 150 and 200 mAh g⁻¹). It is seen that the Si/C composite nanofiber anode made from 15 wt % Si/PAN precursor has small degradation in capacity when current density increases. This result further confirms the good electrochemical performance of this novel type of Si/C carbon nanofiber anode compared with the commercial graphite, owing to its special components, texture and surface properties.

To summarize this Example, Si/PAN and the corresponding Si/C composite nanofibers were prepared through electrospinning the dispersions of Si nanoparticles in PAN/DMF solutions, and thermal treatments of electrospun nanofibers. Their surface morphologies, thermal properties, and crystal structures were characterized using various analytic techniques. The as-prepared Si/C composite nanofibers were subsequently investigated as anode materials for LIBs. It was found that the Si/C composite nanofiber anode exhibits large reversible capacity, stable cycleability, and high rate capability. These desirable attributes are likely due to the Si nanoparticles having a relatively homogeneous dispersion along the nanofibers' surfaces without severe agglomeration and separation during lithium insertion/extraction. Moreover, the unique texture and surface properties affect the electrochemical behaviors by increasing accessible surface areas in anodes, dramatically decreasing lithium-ion diffuse distance, and inducing high rates of electron transfer. These results indicate that the as-prepared Si/C composite nanofibers and other composite nanofibers taught herein are promising candidates for anodes in LIBs.

Although the foregoing description has specifically described electrospinning as a technique for producing the presently disclosed nanofibers, it will be understood that the electrospinning technique is but one example. Other techniques may be suitable for producing the presently disclosed nanofibers, a few non-limiting examples being other types of spinning techniques such as flash spinning, and melt-blowing techniques such as electrostatic melt-blowing.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A nonwoven fabric comprising:
one or more composite nanofibers comprising a carbon base structure and a plurality of nanoparticles retained by the carbon base structure, the nanoparticles comprising a lithium alloy or a lithium alloy precursor.

2. The nonwoven fabric of claim 1, wherein the one or more composite nanofibers is a single nanofiber comprising a plurality of contiguous sections, and one or more of the sections are entangled with one or more other sections.

3. The nonwoven fabric of claim 1, wherein the one or more composite nanofibers comprise a plurality of nanofibers, and one or more of the nanofibers are entangled with one or more other nanofibers.

4. The nonwoven fabric of claim 3, wherein the plurality of nanofibers is arranged as two or more layers of nanofibers with each layer comprising one or more nanofibers.

5. The nonwoven fabric of claim 1, wherein the one or more composite nanofibers have an average length ranging from 100 nm or greater.

6. The nonwoven fabric of claim 1, wherein the one or more composite nanofibers have an average diameter ranging from 10 nm to 5 μm.

7. The nonwoven fabric of claim 1, wherein the one or more composite nanofibers have an aspect ratio of 20 or greater.

8. The nonwoven fabric of claim 1, wherein the one or more composite nanofibers are arranged as a layer having a planar area and a thickness perpendicular to the planar area, and the thickness ranges from 5 nm to 5 mm.

9. The nonwoven fabric of claim 1, wherein the nanoparticles have an average size ranging from 1 to 200 nm.

10. The nonwoven fabric of claim 1, wherein the lithium alloy precursor is selected from the group consisting of metals capable of alloying with lithium, metalloids capable of alloying with lithium, metal oxides capable of alloying with lithium, inorganic salts capable of alloying with lithium, and organic salts capable of alloying with lithium.

11. The nonwoven fabric of claim 1, wherein the lithium alloy precursor is selected from the group consisting of tin, aluminum, iron, zinc, cobalt, nickel, antimony, silver, copper, molybdenum, iron, manganese, magnesium, a metal combination of two or more of the foregoing metals, a metal combination including at least one of the foregoing metals and one or more other metals, silicon, tin oxide, alumina, titanium oxide, cobalt oxide, ferrous oxide, manganese oxide, molybdenum oxide, cobalt chloride, cobalt acetate, cobalt carbonyl, cobalt acetylacetonate, bis(cyclopentadienyl)cobalt, manganese acetylacetonate, manganese sulfate, iron acetate, silicon tetrachloride, silicon tetrabromide, and silicon 2,3-naphthalocyanine dichloride.

12. The nonwoven fabric of claim 1, wherein at least some of the nanoparticles comprise lithium alloyed with the lithium alloy precursor.

13. An electrode, the electrode comprising:
a nonwoven fabric comprising one or more composite nanofibers, the one or more composite nanofibers comprising a carbon base structure and a plurality of nanoparticles retained by the carbon base structure, the nanoparticles comprising a lithium alloy or a lithium alloy precursor; and
an electrically conductive structure disposed on and in electrical communication with the nonwoven fabric.

14. The electrode of claim 13, wherein the lithium alloy precursor is selected from the group consisting of metals capable of alloying with lithium, metalloids capable of alloying with lithium, metal oxides capable of alloying with lithium, inorganic salts capable of alloying with lithium, and organic salts capable of alloying with lithium.

15. The electrode of claim 13, wherein at least some of the nanoparticles comprise lithium alloyed with the lithium alloy precursor.

16. A secondary battery, comprising:
an anode comprising the one or more composite nanofibers of claim 1;
a cathode separated from the anode by a gap; and
an electrolyte disposed in the gap between the anode and the cathode, the electrolyte comprising a material capable of transferring lithium ions between the anode and the cathode in response to charging or discharging the secondary battery.

17. The secondary battery of claim 16, wherein the lithium alloy precursor is selected from the group consisting of metals capable of alloying with lithium, metalloids capable of alloying with lithium, metal oxides capable of alloying with lithium, inorganic salts capable of alloying with lithium, and organic salts capable of alloying with lithium.

18. The secondary battery of claim 16, wherein at least some of the nanoparticles comprise lithium alloyed with the lithium alloy precursor.

19. The secondary battery of claim 16, wherein the cathode comprises lithium or a lithium-inclusive compound.

20. The secondary battery of claim 16, wherein the electrolyte comprises a lithium-inclusive compound.

21. The secondary battery of claim 16, comprising a first electrically conductive structure and a second electrically conductive structure, wherein the anode is disposed on and in electrical communication with the first electrically conductive structure, and the cathode is disposed on and in electrical communication with the second electrically conductive structure.

22. The secondary battery of claim 21, wherein the first electrically conductive structure and the second electrically conductive structure are arranged as a housing enclosing the anode, the cathode and the electrolyte.

23. The secondary battery of claim 16, comprising a housing enclosing the anode, the cathode and the electrolyte.

24. A method for fabricating a carbon/nanoparticle composite nanofiber, the method comprising:
forming a polymer/nanoparticle nanofiber comprising a polymer base structure and a plurality of nanoparticles retained by the polymer base structure, the nanoparticles comprising a lithium alloy or a lithium alloy precursor; and
carbonizing the polymer/nanoparticle nanofiber, wherein the polymer base structure is transformed to a carbon base structure and the nanoparticles are retained by the carbon base structure.

25. The method of claim 24, wherein the carbon/nanoparticle composite nanofiber has an average length ranging from 100 nm or greater.

26. The method of claim 24, wherein the carbon/nanoparticle composite nanofiber has an average diameter ranging from 10 nm to 5 μm.

27. The method of claim 24, wherein the carbon/nanoparticle composite nanofiber has an aspect ratio of 20 or greater.

28. The method of claim 24, comprising entangling one or more sections of the carbon/nanoparticle composite nanofiber with one or more other sections of the carbon/nanoparticle composite nanofiber.

29. The method of claim 24, comprising forming the carbon/nanoparticle composite nanofiber into a nonwoven mat.

30. The method of claim 29, wherein the nonwoven mat has a planar area and a thickness perpendicular to the planar area, and the thickness ranges from 5 nm to 5 mm.

31. The method of claim 24, wherein the nanoparticles have an average size ranging from 1 to 200 nm.

32. The method of claim 24, wherein forming the polymer/nanoparticle nanofiber comprises dissolving the polymer in a solution, dispersing the nanoparticles in the solution to form a mixture, and spinning the mixture.

33. The method of claim 32, wherein spinning comprises electrospinning.

34. The method of claim 24, wherein forming the polymer/nanoparticle nanofiber comprises subjecting the polymer to spinning process or a melt-blowing process.

35. The method of claim 24, wherein carbonizing comprises heating the polymer/nanoparticle nanofiber wherein non-carbon components of the nanofiber are removed.

36. The method of claim 24, further comprising subjecting the polymer/nanoparticle nanofiber or the carbon/nanoparticle composite nanofiber to a lithiating process wherein lithium is alloyed with the lithium alloy precursor to form lithium alloy nanoparticles.

37. The method of claim 24, wherein the lithium alloy precursor is selected from the group consisting of metals capable of alloying with lithium, metalloids capable of alloying with lithium, metal oxides capable of alloying with lithium, inorganic salts capable of alloying with lithium, and organic salts capable of alloying with lithium.

38. The method of claim 24, wherein the lithium alloy precursor is selected from the group consisting of tin, aluminum, iron, zinc, cobalt, nickel, antimony, silver, copper, molybdenum, iron, manganese, magnesium, a metal combination of two or more of the foregoing metals, a metal combination including at least one of the foregoing metals and one or more other metals, silicon, tin oxide, alumina, titanium oxide, cobalt oxide, ferrous oxide, manganese oxide, molybdenum oxide, cobalt chloride, cobalt acetate, cobalt carbonyl, cobalt acetylacetonate, bis(cyclopentadienyl)cobalt, manganese acetylacetonate, manganese sulfate, iron acetate, silicon tetrachloride, silicon tetrabromide, and silicon 2,3-naphthalocyanine dichloride.

39. A carbon/nanoparticle composite nanofiber fabricated according to the method of claim 24.

40. The carbon/nanoparticle composite nanofiber of claim 39, wherein the carbon/nanoparticle composite nanofiber is formed into a nonwoven mat.
